(19) United States
(12) Patent Application Publication
(10) Pub. No.: US 2008/0117223 A1
(43) Pub. Date: May 22, 2008

(54) Display with memory for storing picture data

(76) Inventors: Peter Mayer, Neubiberg (DE); Wolfgang Spirkl, Germering (DE); Markus Balb, Munchen (DE); Christoph Bilger, Munchen (DE); Martin Brox, Munchen (DE); Thomas Hein, Munchen (DE); Michael Richter, Ottobrunn (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/602,716

(22) Filed: Nov. 21, 2006

(51) Int. Cl. G06T 1/60

(52) U.S. Cl. 345/530

(57) ABSTRACT

A display having a screen, and memory for storing picture data is disclosed. In one embodiment, the screen includes a plurality of pixels, the pixels in a first mode of the display being controlled by the picture data stored in the memory, and in a second mode of the display being controlled by picture data received from an external processing unit.

### BACKGROUND

The invention relates to a display, a computer system, a graphics system, and a method for operating a computer system.

Conventional computers, e.g. PCs (Personal Computers), laptops, notebooks, workstation computers, server computers, etc., in general include a main printed circuit board, the so-called motherboard, on which one or a plurality of CPUs (CPU=Central Processing Unit) may be provided.

In addition to the CPU(s), the motherboard may include one or a plurality of plug-in contacts for memory modules, and possibly appropriate BIOS components, coprocessors, cache memory devices, oscillators, etc., and one or a plurality of further plug-in contacts for (further) plug-in cards such as graphics cards, modem cards, sound cards, etc.

The different components of the motherboard, e.g. the above-mentioned memory modules, the CPU, etc. may for exchanging corresponding data, address, and/or control signals be connected with one another via one or a plurality of bus systems.

As memory modules that are to be inserted into the above-mentioned memory plug-in contacts appropriate SIMM or DIMM memory cards may, for instance, be used (SIMM=Single In-Line Memory Module, DIMM=Dual In-Line Memory Module), each of them comprising a plurality of memory devices, e.g. a plurality of RAM devices (RAM=Random Access Memory), in particular DRAM devices (DRAM=Dynamic Random Access Memory).

A RAM device is a memory for storing data under a predetermined address and for reading out the data under this address later. In the case of SRAMs (SRAM=Static Random Access Memory), the individual memory cells consist, e.g., of few, for instance 6, transistors, and in the case of DRAMs (DRAM=Dynamic Random Access Memory) in general only of one single, correspondingly controlled capacitive element.

A graphics card may be inserted into one of the above-mentioned further plug-in contacts, e.g., a respective PCI Express Graphics (PEG) slot, an Accelerated Graphics Port (AGP) slot, etc. may comprise a GPU (GPU=Graphics Processing Unit), and a plurality of memory devices, e.g. a plurality of RAM devices. The RAM devices may be dedicated to the GPU's use, i.e., may constitute dedicated graphics memory. The corresponding graphics card then is called a “dedicated graphics card.”

Alternatively, a GPU might be used that utilizes a portion of the computer's system RAM rather than dedicated graphics memory. Such “shared” or “integrated” graphics systems are typically less expensive to implement in comparison to dedicated graphics systems, but in general are less powerful. Hence, many motherboards comprise an integrated graphics system, and expansion slots/plug-in contacts to add a dedicated graphics card later, if appropriate.

A GPU e.g. might be used for accelerating the memory intensive work of texture mapping and rendering polygons, for accelerating geometric calculations such as translating vertices into different coordinate systems, for operations for drawing rectangles, triangles, circles, arcs, etc., for doing calculations related to 3D computer graphics, motion compensation, interpolation, etc., i.e., to generate and manipulate computer graphics, and to display computer graphics on a respective display device.

As a display device, e.g., a respective CRT (CRT=cathode ray tube) may be used, or e.g. a respective LCD (LCD=Liquid Crystal Display), in particular, a TFT LCD (TFT=Thin Film Transistor).

Conventional display devices such as CRTs, TFT LCDs, etc. are passive devices that simply display pictures corresponding to picture data received from the GPU.

In conventional computer systems, the respective picture data is transmitted from the GPU to the display device at a pre-determined rate, e.g., 60 Hz (“display refresh rate”). The picture data in each case refers to the whole display contents, i.e., to each pixel, and is sent out at the above pre-determined rate even if there are no or only minor changes to the display contents. Hence, the whole graphics system has to be continuously active, consuming a considerable amount of power.

For these or other reasons, there is a need for the present invention.

### SUMMARY

According to one embodiment, a display is provided, having a screen, and memory for storing picture data. In one embodiment, the screen includes a plurality of pixels, the pixels in a first mode of the display being controlled by the picture data stored in the memory, and in a second mode of the display being controlled by picture data received from an external processing unit. Other embodiments relate to a computer system, a graphics system, and a method for operating a computer system.

### BRIEF DESCRIPTION OF THE DRAWINGS

The accompanying drawings are included to provide a further understanding of the present invention and are incorporated in and constitute a part of this specification. The drawings illustrate embodiments of the present invention and together with the description serve to explain the principles of the invention. Other embodiments of the present invention and many of the intended advantages of the present invention will be readily appreciated as they become better understood by reference to the following detailed description.

FIG. 1 schematically illustrates a computer system according to one embodiment of the invention.

FIG. 2 schematically illustrates a motherboard of the computer of the computer system illustrated in FIG. 1.

FIG. 3 schematically illustrates a graphics card that may be inserted into the motherboard illustrated in FIG. 2.

FIG. 4 schematically illustrates a display according to one embodiment of the invention.

FIG. 5 schematically illustrates a portion of a screen of a display according to one embodiment of the invention.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or other changes may be made without departing from the scope of the present invention. The following detailed description, therefore, is not to be taken in a limiting sense, and the scope of the present invention is defined by the appended claims.

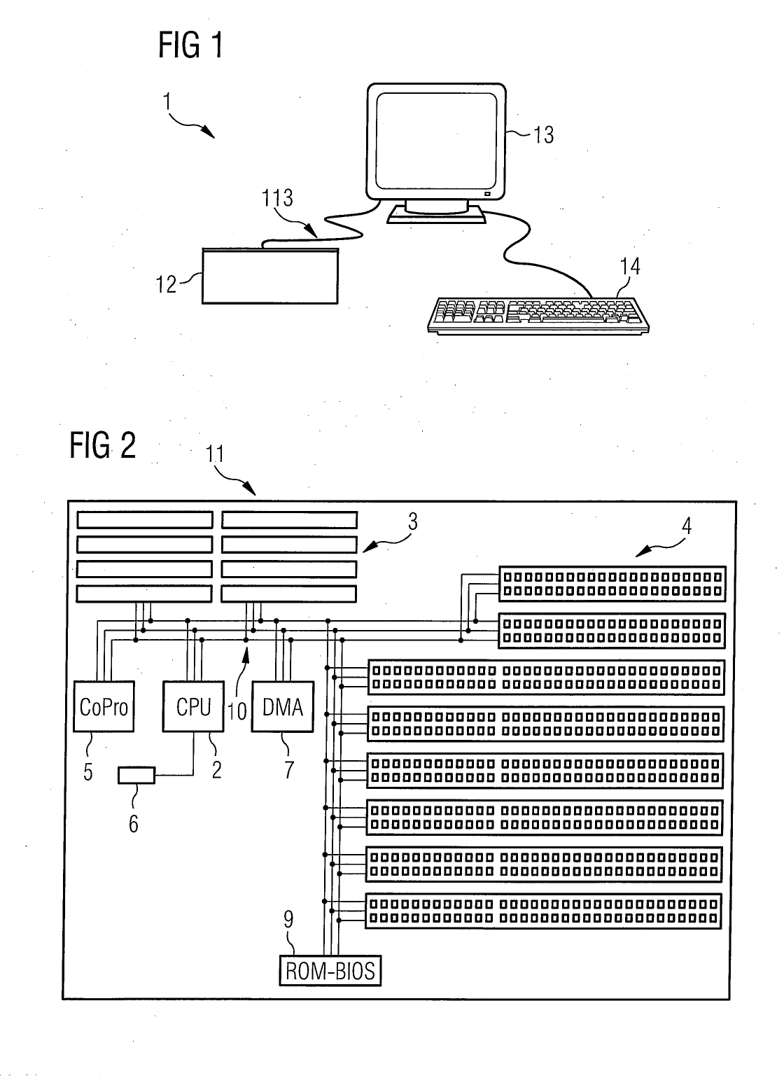

FIG. 1 illustrates a schematic, exemplary representation of a computer system 1, here: a PC (Personal Computer) system 1.

The system 1 comprises a PC (Personal Computer) 12, a display 13, and e.g. an input system, for instance a keyboard 14, and/or a mouse, etc. For carrying out the display control procedure explained in further detail below, instead of the PC 12, correspondingly similar, a laptop, a notebook, a workstation computer, a server computer, etc. might be used, or—generally speaking any electronic device being connected to or comprising a display.

The display 13 may as will be described in further detail below, e.g., be a respective specially designed CRT (CRT=cathode ray tube), or, e.g., a respective specially designed LCD (LCD=Liquid Crystal Display), in particular, a specially designed TFT LCD (TFT=Thin Film Transistor).

For example, the display 13 may be a TN+Film (Twisted Nematic) display, an IPS (In-Plane Switching), S-IPS (Super-IPS), or TW-IPS (True Wide IPS) display, a PVA (Patterned Vertical Alignment) or S-PVA (Super Patterned Vertical Alignment) display, etc.

Referring now to FIG. 2, there is illustrated by way of example a schematic illustration of the motherboard 11 of the PC (Personal Computer) 12 illustrated in in FIG. 1.

The motherboard 11 comprises a CPU 2 (CPU=Central Processing Unit) as well as a plurality of plug-in contacts 3 for memory modules, a plurality of further plug-in contacts 4 for (further) plug-in cards, a coprocessor component 5, an oscillator 6, a DMA component 7 (DMA=Direct Memory Access), a ROM-BIOS component 9 (ROM=Read Only Memory; BIOS=Basic Input Output System), and a plurality of cache memory devices (not illustrated).

As results from FIG. 2, several components of the motherboard 11 e.g. the CPU 2, the memory module plug-in contacts 3, the further plug-in contacts 4, etc. are connected with each other via one or a plurality of bus systems with corresponding data, address, and/or control busses, e.g. via a PCI bus system 10 (PCI=Peripheral Component Interconnect).

Into the further plug-in contacts 4, in line with the requirements of the user, one or a plurality of plug-in cards, e.g. a graphics card, a modem card, a sound card, etc., may be inserted.

Further, into the above memory module plug-in contacts 3, respective SIMM or DIMM memory cards may be inserted (SIMM=Single In-Line Memory Module, DIMM=Dual In-Line Memory Module), each comprising a plurality of memory devices, e.g. a plurality of RAM devices (RAM=Random Access Memory), in particular DRAM devices (DRAM=Dynamic Random Access Memory).

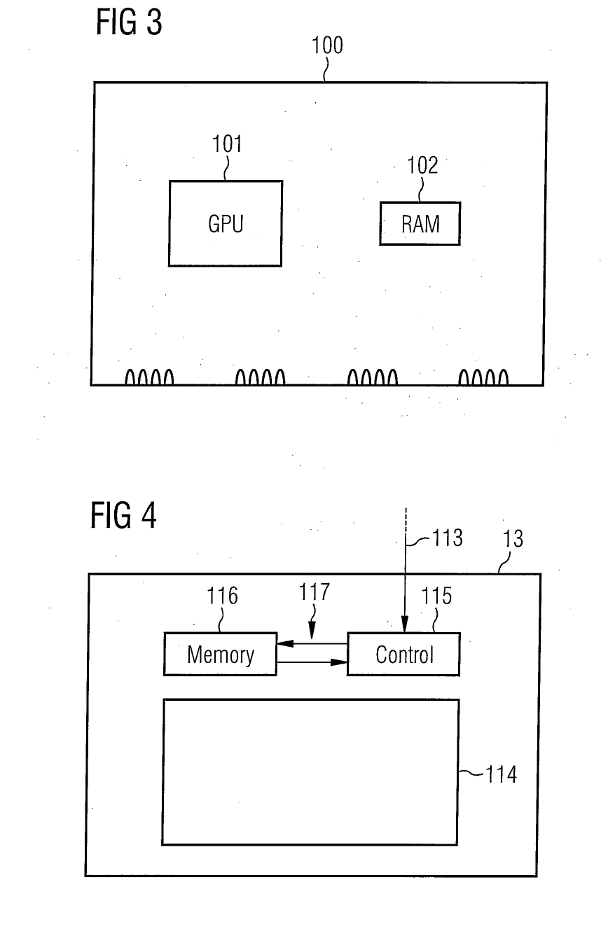

FIG. 3 schematically illustrates a graphics cards 100 that, e.g., may be inserted into one of the further plug-in contacts 4 of the motherboard 11 illustrated in FIG. 2, e.g., a respective PCI Express Graphics (PEG) slot (or alternatively, e.g. an Accelerated Graphics Port (AGP) slot, or any other plug-in contact for graphics cards).

The graphics card 100 includes a GPU 101 (GPU=Graphics Processing Unit), and as graphics memory one or a plurality of memory devices 102. The GPU 101 and the memory device(s) 102 constitute a respective graphics system.

In particular, the graphics card 100 may, e.g., include a plurality of RAM devices 102 (RAM=Random Access Memory), for instance, DRAM devices (DRAM=Dynamic Random Access Memory).

In the present embodiment, the graphics system may, e.g., be a dedicated graphics system, and the graphics card 100 a dedicated graphics card, i.e., the RAM devices 102 on the graphics card 100 may be dedicated to the GPU's use (“dedicated graphics memory”).

Instead of the above dedicated graphics system/the dedicated graphics card 100 illustrated in FIG. 3 (and/or in addition thereto), in the computer system 1 illustrated in FIG. 1, a “shared” or “integrated” graphics system might be provided, i.e., a (further) GPU that utilizes a portion of the computer's system RAM rather than dedicated graphics memory.

For instance, on the motherboard 11 illustrated in FIG. 2, an integrated graphics system might be provided; the above expansion slots further plug-in contacts 4 might be used to add the above dedicated graphics card 100 dedicated graphics system to the system 1, if appropriate.

The GPU 101 on the graphics card 100, and/or the (further) GPU of the integrated graphics system correspondingly similar as conventional GPUs, e.g., might be used for accelerating the memory-intensive work of texture mapping and rendering polygons, for accelerating geometric calculations such as translating vertices into different coordinate systems, for operations for drawing rectangles, triangles, circles, arcs, etc., for doing calculations related to 3D computer graphics, motion compensation, interpolation, etc., i.e., to generate and manipulate computer graphics, and to display computer graphics on the above display 13 illustrated in FIG. 1 (or one or several additional displays (not illustrated)).

The graphics card 100, and/or the GPU 101, and/or the RAM devices 102, i.e., the above dedicated graphics system (and/or correspondingly similar the above “shared” or “integrated” graphics system (and/or the above (further) GPU on the motherboard 11)) may be operated in at least two different modes: A “working mode”, and a “static screen mode”.

According to an embodiment of the invention, after power up of the computer system 1, the graphics card GPU 101 first is brought into the working mode. In the working mode, correspondingly similar as conventional GPUs, the GPU 101 transmits respective picture data to the display 13 at a pre-determined rate, e.g., 60 Hz (“display refresh rate”).

In the working mode, just as is the case in conventional graphics systems, the picture data in each case refers to the whole display contents, e.g., to each pixel.

The picture data e.g. might be transmitted to the display 13 via a respective wired connection, e.g., via one of the above bus systems 10, and/or a respective cable 113 provided between the PC 12, and the display 13. Alternatively, the picture data at least partly might be transmitted wirelessly (e.g., via one of the above bus systems 10, and a wireless connection between the PC 12, and the display 13), etc.

FIG. 4 schematically illustrates a display 13 according to an embodiment of the invention.

The display 13 comprises a screen 114, a control device 115, and other than conventional displays, and as will be described in further detail below one or several memory devices, e.g. one or several of RAM devices (RAM=Random Access Memory), in particular one or several SRAM devices (SRAM=Static Random Access Memory).

In the above working mode, the picture data received from the GPU 101 at the above pre-determined rate, e.g., 60 Hz (“display refresh rate”) is used by the control device 115 to correspondingly control respective picture elements/pixels of the screen 114 of the display 13. In addition, data identical or corresponding to the picture data received from the GPU 101 is stored in the above one or several RAM device(s) 116, e.g. also under control of the control device 115.

For this purpose, and as is illustrated in FIG. 4, the control device 115 and the RAM device(s) 116 might be connected by respective data, address, and/or control signal lines 117.

The rate at which the picture data received from the GPU 101 (or data corresponding thereto) is stored in the RAM device(s) might correspond to the above rate at which the picture data is received from the GPU 101, e.g., 60 Hz. Hence, each 1/60 seconds the data previously stored in the RAM device(s) 116 is replaced by new picture data received from the GPU 101 (or data correspond thereto).

In the working mode, the CPU 2, or the GPU 101 continuously monitors whether the graphics card/GPU 101 is to be brought from the working mode into the above static screen mode. This is the case, for instance, if for a predetermined amount of time, e.g., 15 seconds, 1 minute, etc., no changes to the display contents had occurred.

If it was detected that the graphics card/GPU 101 is to be brought into the static screen mode, the GPU 101 sends a respective mode change signal via the above wired and/or wireless connection, e.g., the above cable 113 to the control device 115. After sending out the mode change signal, the graphics card/GPU 101 as explained in further detail below is brought into the static screen mode.

In response to receiving the mode change signal from the GPU 101, the control device 115 reads out the picture data or the data corresponding thereto previously stored in the RAM device(s) 116, and uses this data (instead of picture data received from the GPU 101) to correspondingly control the picture elements/pixels of the screen 114 of the display 13. This process—reading out the (picture) data stored in the RAM device(s) 116, and correspondingly controlling the picture elements/pixels of the screen 114—might be repeated at a rate which corresponds to the above rate at which the picture data in the above working mode is received from the GPU 101, e.g., 60 Hz (“display self refresh rate”).

As the data stored in the RAM device(s) 116 remains the same in the static screen mode, the picture shown at the display 13 the display contents remains the same. Hence, the previously illustrated picture is “frozen” at the screen 114.

In the static screen mode, the graphics card 100, and/or the GPU 101 consumes less power, than in the working mode or no or almost no power at all.

This might be achieved by providing the GPU 101 in the static screen mode with a clock signal which has a lower frequency (“static screen mode frequency”), than in the working mode (“working mode frequency”) (alternatively, the GPU 101 other than in the working mode—in the static screen mode might be provided with no clock signal at all, thereby completely “shutting down” the GPU 101 the graphics system).

Alternatively or additionally, the GPU 101 in the static screen mode might be disconnected from power supply.

In the static screen mode, the GPU 101 does not transmit any picture data to the display 13 (or less picture data than in the working mode).

In the static screen mode, correspondingly similar as in the working mode, the CPU 2 (or the GPU 101) continuously monitors whether the graphics card/GPU 101 is to be brought back from the above static screen mode to the working mode. This is the case, for instance, if the display contents is to be changed again (or will have to be changed within a predetermined period of time, e.g., the next few seconds).

If it was detected that the graphics card/GPU 101 is to be brought back into the working mode, the GPU 101 again is connected to power supply, and/or the frequency of the clock signal provided to the GPU 101 is increased to the above “working mode frequency” (or—in the case of a complete shut down of the GPU 101—again a clock signal with the above working mode frequency is provided to the GPU 101).

The GPU 101 then sends a respective mode change back signal via the above wired and/or wireless connection, e.g., the above cable 113 to the control device 115.

Thereafter, again, the GPU 101 restarts to transmit respective picture data to the display 13 at the above predetermined rate (“display refresh rate”).

In response to receiving the mode change back signal from the GPU 101, the control device 115 of the display 13 stops the above process of repeatedly reading out the (picture) data stored in the RAM device(s) 116.

Instead, the (new) picture data received from the GPU 101 at the above pre-determined rate (“display refresh rate”) or data corresponding thereto is stored in the above one or several RAM device(s) 116, and is used by the control device 115 to correspondingly control the picture elements/pixels of the screen 114 of the display 13.

Hence, the picture illustrated at the display 13 the display contents is changed.

The rate at which the picture data received from the GPU 101 (or data corresponding thereto) is stored in the RAM device(s) again might correspond to the above rate at which the picture data is received from the GPU 101, e.g., 60 Hz.

According to an embodiment of the invention and other than schematically illustrated in FIG. 4, the individual memory cells of the above RAM device(s) 116 might be provided in a “distributed” fashion, e.g. on the screen 114 of the display 13.

For instance, for each picture element pixel of the screen 114 of the display 13, a respective associated RAM, in particular SRAM memory cell might be provided.

Each SRAM memory cell correspondingly similar as a conventional SRAM memory cell might include several, for instance 6, transistors.

Each picture element/pixel e.g. might be adapted to display one of the three colors red, green, and blue.

Each RAM, in particular SRAM memory cell might store the brightness information of the corresponding associated picture element/pixel, i.e., might store whether the corresponding pixel shall be “dark”, or “bright”, and might be located close to the corresponding picture element pixel.

In this case, the screen 114 of the display 13 may include a relatively high number of sectors/segments arranged in respective rows and columns, each sector/segment comprising a SRAM memory cell, and an associated picture element/pixel.

Hence, the number of RAM, in particular SRAM memory cells provided on the screen 114 corresponds to the number of picture elements/pixels.

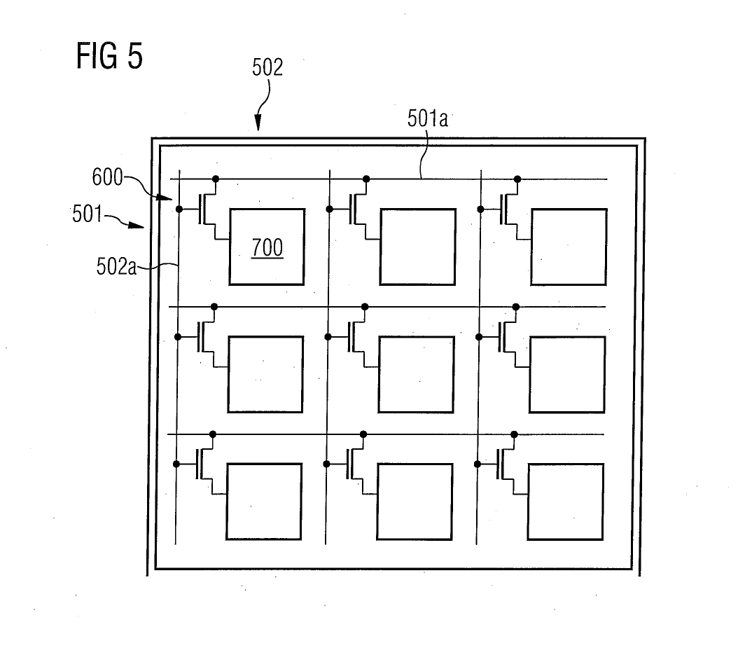

In an alternative embodiment for instance if a screen layout as illustrated in FIG. 5 is used, wherein each picture element/pixel 700 is controlled by a respective transistor 600, each transistor 600 being controlled by a respective row segment control line 501a, and a respective column segment control line 502a for each row 501 of picture elements/pixels, and for each column 502 of picture elements/pixels, one single respective associated SRAM memory cell might be provided. Each SRAM memory cell associated to a respective row 501 then might, e.g., store information regarding the status (“logic high”, or “logic low”) of an associated row segment control line 501a, and each SRAM memory cell associated to a respective column 502 might, e.g., store information regarding the status (“logic high”, or “logic low”) of an associated column segment control line 502a. In this case the number of SRAM memory cells is smaller, than the number of picture elements/pixels, with the total number of SRAM memory cells e.g. corresponding to the number of rows 501 the number of row segment control lines 501a, plus the number of columns 502 the number of column segment control lines 502a provided on the screen 114.

The above picture elements/pixels, and the above SRAM memory cells might be formed on one and the same substrate, e.g., a substrate conventionally used for building TFT LCD picture elements/pixels.

As a substrate for building the above TFT LCD picture elements/pixels, and the associated SRAM memory cells, for instance, a respective silicon layer might be used, e.g. as with conventional TFT LCD displays a silicon layer deposited from Silane gas, i.e., other than with conventional RAM devices a respective amorphous or polycrystalline silicon layer.

In this embodiment, the TFT LCD picture elements/pixels, and the associated SRAM memory cells at least partly are built by use of corresponding process steps as conventionally used for the building of TFT LCD picture elements/pixels (whereby at least some of the processes at the same time serve to build part of a respective TFT LCD picture element/pixel, and part of a respective memory cell).

Alternatively, a conventional SRAM chip might be used as RAM device 116. In this case, the SRAM chip is built on a first substrate, and the screen 114 (with the TFT LCD picture elements/pixels, etc.) on a second, separate substrate.

Thereby, the above picture elements/pixels might be built on a substrate conventionally used for building TFT LCD picture elements/pixels, and the SRAM memory cells of the SRAM chip on a different substrate conventionally used for building SRAM chips.

For instance, as with conventional TFT LCD displays a silicon layer deposited from Silane gas, i.e., a respective amorphous or polycrystalline silicon layer might be used to build the above screen 114 (with the TFT LCD picture elements/pixels, etc.).

In contrast thereto, for building the SRAM chip, a single crystal silicon substrate grown from liquid silicon might be used.

The SRAM chip might be directly attached to the screen 114 the TFT LCD display, e.g., using “micro bump” or “micro flip chip” technology.

In this case, the SRAM chip might be attached upside-down directly on an upper layer of the screen 114 TFT LCD display, with respective contacts/flip pads of an upper layer of the SRAM chip directly without any bond wire soldered to respective contacts/flip pads of the upper layer of the TFT LCD display, e.g. using respective reflow soldering processes.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A display, comprising:
a screen; and
a memory for storing picture data.

2. The display of claim 1, wherein the memory comprises a plurality of memory cells.

3. The display of claim 2, wherein the memory cells are RAM memory cells.

4. The display of claim 3, wherein the RAM memory cells are SRAM memory cells.

5. The display of claim 1, the screen comprising a plurality of pixels, the pixels in a first mode of the display being controlled by the picture data stored in the memory, and in a second mode of the display being controlled by picture data received from an external processing unit.

6. The display of claim 5, wherein the external processing unit is a graphics processing unit.

7. The display of claim 1, wherein the display is a CRT.

8. The display of claim 1, wherein the display is a TFT.

9. The display of claim 3, wherein the RAM memory cells are comprised on a separate RAM chip.

10. The display of claim 9, the screen comprising a plurality of pixels, the RAM chip being directly attached to the screen.

11. The display of claim 10, wherein pads of the RAM chip are directly soldered to pads of the screen.

12. The display of claim 3 comprising:
a substrate on which a plurality of pixels are formed, the RAM memory cells being formed on the same substrate, as the plurality of pixels.

13. The display of claim 12 comprising:
each RAM memory cell storing brightness information for an associated pixel.

14. The display of claim 12, the substrate comprising a plurality of segments, wherein on each segment a pixel and a memory cell is formed.

15. A method for operating a computer system, comprising:
sending picture data from a processing unit to a display; and
storing the picture data or data corresponding thereto in a memory of the display.

16. The method of claim 15, additionally comprising:
in a first mode of the system, controlling pixels of a screen of the display in accordance with the picture data received from the processing unit.

17. The method of claim 16, additionally comprising:
in a second mode of the system, controlling the pixels in accordance with the picture data or the data corresponding thereto stored in the memory.

18. The method of claim 17, comprising:
defining the processing unit to be a graphics processing unit.

19. The method of claim 18, wherein in the second mode of the system, comprising:
bringing the graphics processing unit into a state where it consumes less power, than in the first mode of the system.

20. A graphics system, comprising:
a processing unit, the processing unit in a first mode sending picture data to a display; and
a device for bringing the processing unit in a second mode, wherein the processing unit in the second mode consumes less power than in the first mode.

21. The graphics system of claim 20, wherein the device is configured to bring the processing unit in the second mode when it is detected that the contents of the display is to remain unchanged or has remained unchanged.

22. The graphics system of claim 21, comprising:
a clock generator, the clock generator in the first mode providing a clock with a first frequency to the processing unit, and in the second mode providing a clock with a second frequency to the processing unit, the second frequency being smaller, than the first frequency.

23. The graphics system of claim 21, comprising:
a clock generator, the clock generator in the first mode providing a clock to the processing unit, wherein in the second mode no clock is provided to the processing unit by the clock generator.

24. The graphics system of claim 21, comprising:
a device for connecting the processing unit to a power supply in the first mode, and for disconnecting the processing unit from the power supply in the second mode.

25. A computer system, comprising:
a graphics processing unit; and
a display, the display comprising memory for storing picture data.

26. The computer system of claim 25, wherein the display comprises:
a plurality of pixels, the pixels in a first mode of the system being controlled by the picture data stored in the memory, and in a second mode of the system being controlled by picture data sent from the graphics processing unit to the display.

27. The computer system of claim 26, wherein the memory comprises a plurality of memory cells provided on a separate memory chip.

28. The computer system of claim 27, wherein the plurality of pixels are provided on a screen of the display, the memory chip being directly attached to the screen.

29. The computer system of claim 26, wherein the memory comprises a plurality of memory cells, and wherein the plurality of pixels are provided on a substrate, the memory cells being provided on the same substrate, as the plurality of pixels.

30. A display, comprising:
a screen; and
memory means for storing picture data.
